(19) United States
(12) Patent Application Publication
(10) Pub. No.: US 2025/0062488 A1
(43) Pub. Date: Feb. 20, 2025

(54) BATTERY MODULE INCLUDING VENT MANIFOLD HAVING A SELECTIVELY ACTIVATED FLUID INLET

(71) Applicant: GM Global Technology Operations LLC, Detroit, MI (US)

(72) Inventors: Ryan Patrick Hickey, Austin, TX (US); Peter Paul Andruskiewicz, IV, Ann Arbor, MI (US); David R. Clark, Grosse Pointe Woods, MI (US); Matthew Swift, Atlanta, GA (US); Chih-hung Yen, Bloomfield Hills, MI (US)

(21) Appl. No.: 18/451,293

(22) Filed: Aug. 17, 2023

(51) Int. Cl. H01M 50/358; B60L 50/64; H01M 10/613; H01M 10/625; H01M 10/6567; H01M 50/209; H01M 50/249

(52) U.S. Cl. CPC H01M 50/358; B60L 50/64; H01M 10/613; H01M 10/625; H01M 10/6567; H01M 50/209; H01M 50/249; H01M 2200/10; H01M 2200/20; H01M 2220/20

(57) ABSTRACT

A battery module, in accordance with a non-limiting example, includes a module housing including a plurality of walls defining an interior, and a plurality of battery cells arranged in the interior. Each of the plurality of battery cells includes a vent. A vent manifold is connected to each of the plurality of battery cells. The vent manifold includes a central passage fluidically connected to the vent in each of the plurality of battery cells and a fluid inlet that selectively allows passage of an amount of fluid into select ones of the plurality of battery cells.

### INTRODUCTION

The subject disclosure relates to the art of battery assemblies and, more particularly, to a battery module including a vent manifold having a selectively activated fluid inlet.

Rechargeable battery systems often include multiple connected battery cells arranged in a housing to form a battery module. Multiple battery modules are connected and arranged in a housing to form a battery assembly. The battery assembly may be used to provide motive power to, for example, a vehicle such as an automobile. In such an environment, the battery assembly is connected to a load, such as a drive motor and a charge port that may be connected to a source of electric energy. The battery assembly discharges into the drive motor to provide power to the vehicle and is charged through the charge port.

When the battery assembly is cycled, that is going through periods of discharging into the load and being charged through the charge port, heat is generated in the battery cells. If a battery cell is damaged, discharged too deeply, or recharged improperly, the heat generated may be so great as to lead to a chemical reaction that may ultimately cause a thermal runaway condition. Thermal runaway is difficult to stop and thus preventing thermal runaway is a design consideration when producing batteries. Accordingly, it is desirable to provide a battery module with a system that limits heat spread through a battery assembly.

### SUMMARY

A battery module, in accordance with a non-limiting example, includes a module housing including a plurality of walls defining an interior, and a plurality of battery cells arranged in the interior. Each of the plurality of battery cells includes a vent. A vent manifold is connected to each of the plurality of battery cells. The vent manifold includes a central passage fluidically connected to the vent in each of the plurality of battery cells and a fluid inlet that selectively allows passage of an amount of fluid into select ones of the plurality of battery cells.

In addition to one or more of the features described herein the vent manifold includes a first surface coupled to each of the plurality of battery cells, a second surface extending parallel to and spaced from the first surface, a first side surface, and a second side surface extending between and connected to the first surface and the second surface, the fluid inlet being arranged in one of the first side surface and the second side surface.

In addition to one or more of the features described herein a thermally responsive hatch disposed over the fluid inlet.

In addition to one or more of the features described herein a thermally responsive adhesive selectively connecting the thermally responsive hatch to the one of the first side surface and the second side surface.

In addition to one or more of the features described herein the vent manifold includes a first hatch support arranged on one side of the fluid inlet and a second hatch support arranged on a second side of the fluid inlet, the thermally responsive hatch being selectively supported between the first hatch support and the second hatch support closing the fluid inlet.

In addition to one or more of the features described herein the vent manifold is formed from a thermally responsive material configured to expand when exposed to pressurized hot gases.

In addition to one or more of the features described herein a fluid additive module connected to the vent manifold, the fluid additive module including a thermal runaway specific material that is selectively added to the amount of fluid passing through the vent module into the one of the plurality of battery cells.

In addition to one or more of the features described herein the fluid additive module is mounted to the one of the first side surface and the second side surface over the fluid inlet.

In addition to one or more of the features described herein an amount of fluid arranged in the interior of the module housing, the fluid inlet selectively passing a portion of the amount of fluid from the interior to flow through the vent of the select ones of the plurality of battery cells.

In addition to one or more of the features described herein the vent manifold includes a first manifold portion coupled to each of the plurality of battery cells and a second manifold portion connected to the first manifold portion through a thermally responsive manifold seam, the fluid inlet being arranged at the thermally responsive seam.

A vehicle, in accordance with a non-limiting example, includes a body including a passenger compartment, a drive motor mounted in the body, and a rechargeable energy storage system including a battery assembly mounted to the body. The battery assembly includes a housing including a base wall and a plurality of side walls that are connected to the base wall. A plurality of battery modules is arranged in the housing. Each of the plurality of battery modules includes a module housing including a plurality of walls defining an interior. A plurality of battery cells is arranged in the interior. Each of the plurality of battery cells includes a vent. A vent manifold is connected to each of the plurality of battery cells. The vent manifold includes a central passage fluidically connected to the vent in each of the plurality of battery cells and a fluid inlet that selectively allows passage of an amount of fluid into select ones of the plurality of battery cells.

In addition to one or more of the features described herein the vent manifold includes a first surface coupled to each of the plurality of battery cells, a second surface extending parallel to and spaced from the first surface, a first side surface, and a second side surface extending between and connected to the first surface and the second surface, the fluid inlet being arranged in one of the first side surface and the second side surface.

In addition to one or more of the features described herein a thermally responsive hatch disposed over the fluid inlet.

In addition to one or more of the features described herein a thermally responsive adhesive selectively connecting the thermally responsive hatch to the one of the first side surface and the second side surface.

In addition to one or more of the features described herein the vent manifold includes a first hatch support arranged on one side of the fluid inlet and a second hatch support arranged on a second side of the fluid inlet, the thermally responsive hatch being selectively supported between the first hatch support and the second hatch support closing the fluid inlet.

In addition to one or more of the features described herein the vent manifold is formed from a thermally responsive material configured to expand when exposed to pressurized hot gases.

In addition to one or more of the features described herein a fluid additive module connected to the vent manifold, the fluid additive module including an amount of endothermic material that is selectively added to the amount of fluid passing through the vent module into the one of the plurality of battery cells.

In addition to one or more of the features described herein the fluid additive module is mounted to the one of the first side surface and the second side surface over the fluid inlet.

In addition to one or more of the features described herein an amount of fluid arranged in the interior of the module housing, the fluid inlet selectively passing a portion of the amount of fluid from the interior to flow through the vent of the select ones of the plurality of battery cells.

In addition to one or more of the features described herein the vent manifold includes a first manifold portion coupled to each of the plurality of battery cells and a second manifold portion connected to the first manifold portion through a thermally responsive manifold seam, the fluid inlet being arranged at the thermally responsive seam.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a left side view of a vehicle including a battery assembly having a battery module including a vent manifold including a selectively activated fluid inlet, in accordance with a non-limiting example;

FIG. 2 is a view of the battery assembly without a cover showing the battery module, in accordance with a non-limiting example;

FIG. 3 is a perspective view of a battery module of the battery assembly of FIG. 2 illustrating a vent manifold, in accordance with a non-limiting example;

FIG. 4 is a side cross section view of the battery module of FIG. 3 taken through the line 4-4, in accordance with a non-limiting example;

FIG. 5A is a side section view of the vent manifold prior to venting gases, in accordance with a non-limiting example;

FIG. 5B is a side section view of the vent manifold of FIG. 5A venting gases, in accordance with a non-limiting example;

FIG. 5C is a side section view of the vent manifold of FIG. 5B after venting gases showing the selectively activated fluid inlet passage open to fluid, in accordance with a non-limiting example;

FIG. 6A is a side section view of the vent manifold prior to venting gases, in accordance with another non-limiting example;

FIG. 6B is a side section view of the vent manifold of FIG. 6A venting gases, in accordance with a non-limiting example;

FIG. 6C is a side section view of the vent manifold of FIG. 6B after venting gases showing the selectively activated fluid inlet passage open to fluid, in accordance with a non-limiting example;

FIG. 7 is a side section view of the vent manifold in accordance with another non-limiting example;

FIG. 8 is a perspective view of a battery module of the battery assembly of FIG. 2 illustrating a vent manifold, in accordance with another non-limiting example;

FIG. 9 is a side section view of the battery module of FIG. 8, in accordance with a non-limiting example; and

FIG. 10 is a side section view of the battery module of FIG. 2 in accordance with yet still another non-limiting example.

### DETAILED DESCRIPTION

The following description is merely exemplary in nature and is not intended to limit the present disclosure, its application or uses. It should be understood that throughout the drawings, corresponding reference numerals indicate like or corresponding parts and features.

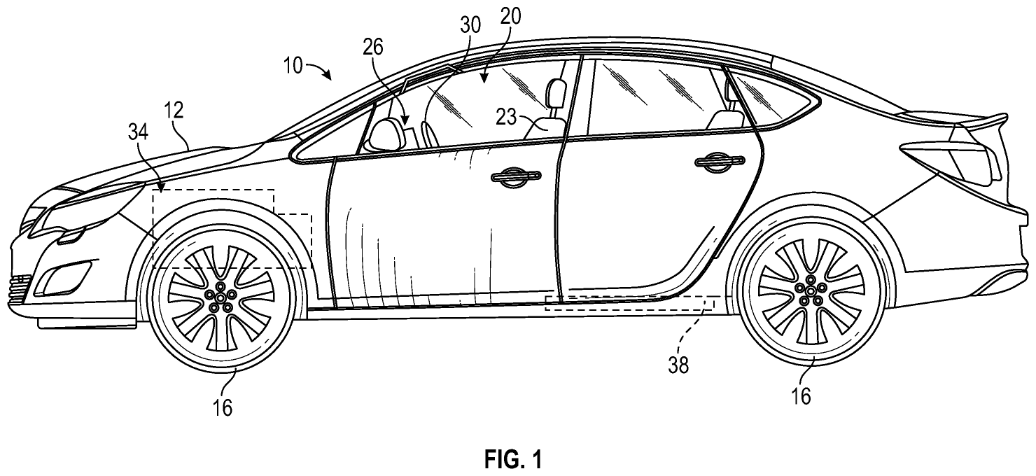

A vehicle, in accordance with a non-limiting example, is indicated generally at 10 in FIG. 1. Vehicle 10 includes a body 12 supported on a plurality of wheels 16. Body 12 defines, in part, a passenger compartment 20 having seats 23 positioned behind a dashboard 26. A steering control 30 is arranged between seats 23 and dashboard 26. Steering control 30 is operated to control orientation of select ones of the plurality of wheels 16. Vehicle 10 includes an electric drive motor 34 that provides power to one or more of the plurality of wheels 16.

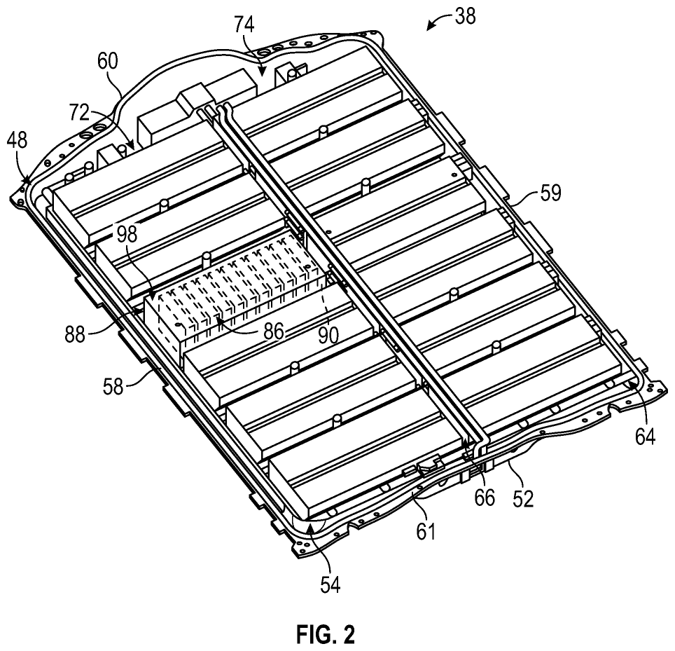

A rechargeable energy storage system (RESS) or battery assembly 38 is arranged in body 12 and provides power to electric drive motor 34. At this point, it should be understood that the location of electric drive motor 34 and battery assembly 38 may vary. Referring to FIG. 2, battery assembly 38 includes a housing 48 including a base wall 52 and a plurality of side walls 54. Side walls 54 include a first side wall 58, a second side wall 59, a third side wall 60, and a fourth side wall 61 that collectively define an interior zone 64. Housing 48 is shown to include a mid-line 66 in accordance with a non-limiting example. Mid-line 66 extends between third side wall 60 and fourth side wall 61 and is equally spaced from first side wall 58 and second side wall 59.

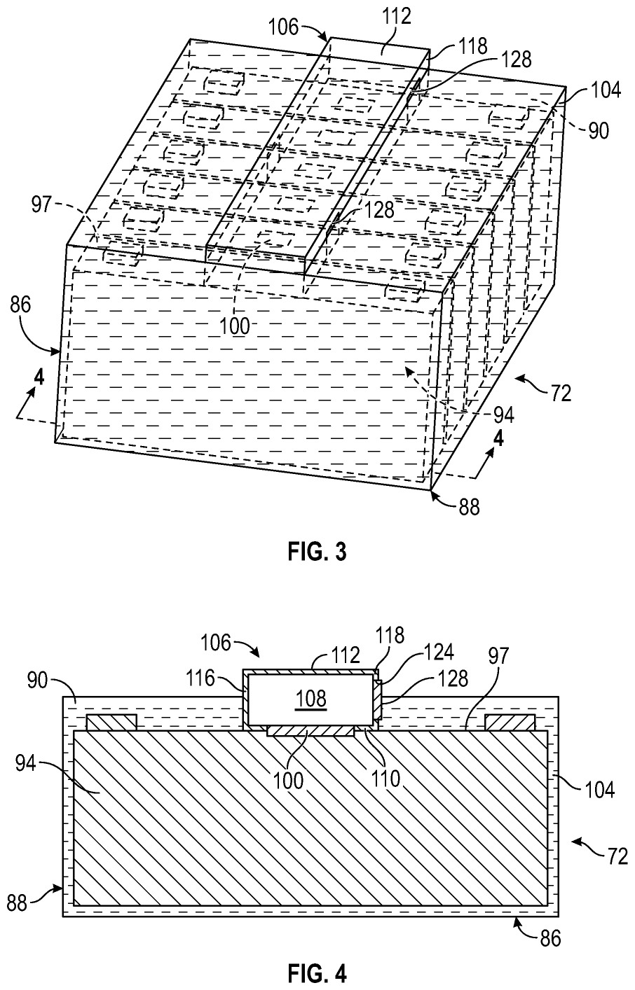

In a non-limiting example, a first plurality of battery modules 72 is arranged between mid-line 66 and first side wall 58 and a second plurality of battery modules 74 arranged between mid-line 66 and second side wall 59. Reference will now follow to FIG. 3 with continued reference to FIG. 2 in describing one of the first plurality of battery modules 72 with an understanding that remaining ones of the first plurality of battery modules 72 and the second plurality of battery modules 74 include corresponding structure.

Battery module 72 includes a module housing 86 having a plurality of walls 88 that define an interior 90. In a non-limiting example, a plurality of battery cells 94 are arranged in interior 90. Each of the plurality of battery cells 94 includes an outer surface 97 supporting an anode (not separately labeled) a cathode (also not separately labeled) and a vent 100. As will be detailed herein, vent 100 provides a passage that allows gasses that may be generated in a corresponding one of the plurality of battery cells 94 to escape to ambient. An amount of fluid 104 fills a portion of module housing 86. In a non-limiting example, each of the plurality of battery cells 94 is fully immersed in the amount of fluid 104.

In a non-limiting example, a vent manifold 106 extends across, and is connected to, outer surface 97 of each of the plurality of battery cells 94. Referring to FIG. 4 with continued reference to FIG. 3, vent manifold 106 includes a central passage 108 that is fluidically connected to each vent 100 of the plurality of battery cells 94. Central passage 108 is defined by a first surface 110 connected to each of the plurality of battery cells 94, a second surface 112 that extends parallel to and is spaced from first surface 110, a first side surface 116 and a second side surface 118. First side surface 116 and second side surface 118 extend between and connect with first surface 110 and second surface 112.

In a non-limiting example, a fluid inlet 124 is formed in second side surface 118 of vent manifold 106. Fluid inlet 124, as will be detailed herein, selectively exposes central passage 108 to some portion of the amount of fluid 104 in module housing 86. As will be detailed herein, in the event of an over temperature condition in one of the plurality of battery cells 94 that results in gas generation, a portion of the amount of fluid 104 may flow into the one of the plurality of cells after the gas vents in order to start a cooling process.

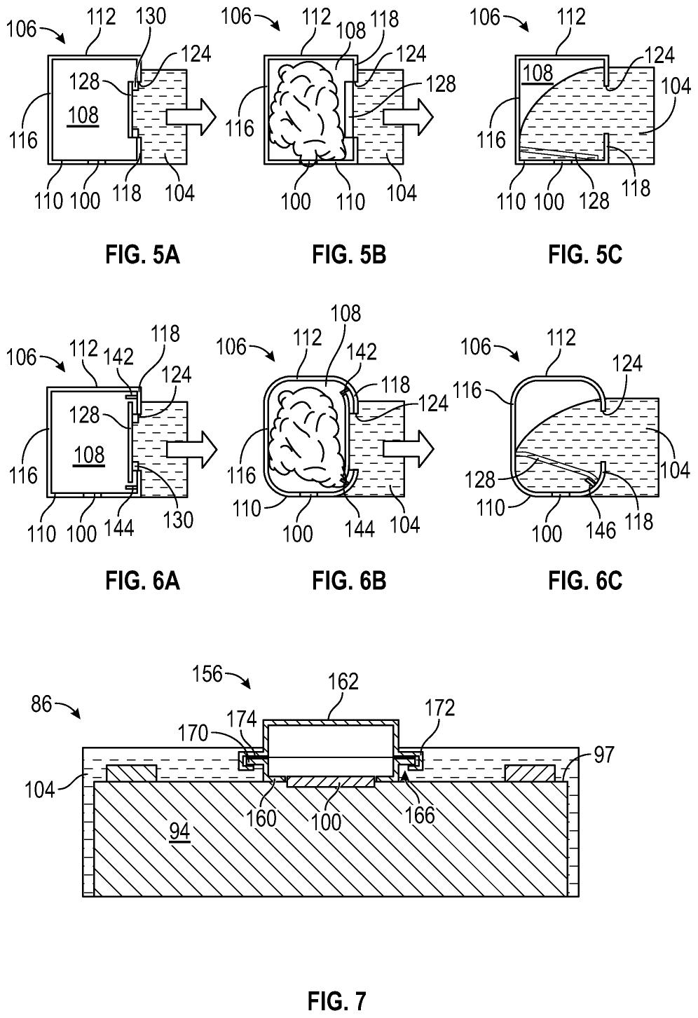

In a non-limiting example, a thermally responsive hatch 128 is mounted over fluid inlet 124 such as shown in FIG. 5A. In one non-limiting example, thermally responsive hatch 128 may be formed from a thermally responsive material, such as a material that will shrink, melt, or otherwise change geometry when exposed to a selected temperature. In another non-limiting example, thermally responsive hatch 128 may be secured to second side surface 118 with a thermally responsive material 130 that ceases to retain bonding properties when exposed to a selected temperature. In yet another non-limiting example, a mechanism (not shown) may shift thermally responsive hatch 128 to uncover fluid inlet 124 when gases at a selected temperature fill central passage 108.

In a non-limiting example, in the event a thermal runaway condition exists in one of the plurality of battery cells 94, high pressure, high temperature gases will be generated. At this point, it should be understood that high temperature, high pressure gases are gases that may have a temperature exceeding 1000° C. and a pressure that exceeds 150 kPa. The high temperature, high pressure gases will force open the vent 100 associated with the one of the plurality of battery cells 94 and exhaust into vent manifold 106 as shown in FIG. 5B. As the high temperature, high pressure gases flow through vent manifold 106 to, for example, ambient, thermally responsive hatch 148 is activated. While present in central passage 108, the high temperature, high pressure gases hold thermally responsive hatch 128 closed.

Once the high temperature, high temperature high pressure gases dissipate, thermally responsive hatch 128 uncovers fluid inlet 124 as shown in FIG. 5C allowing a portion of the amount of fluid 104 to flow into vent manifold 106, pass through vent 100, and into the one of the plurality of battery cells 94 experiencing thermal runaway. The portion of the amount of fluid will reduce temperatures thereby reducing the likelihood that thermal runaway will spread to additional ones of the plurality of battery cells 94.

In a non-limiting example shown in FIG. 6A, vent manifold 106 is formed from a thermally responsive material that may change geometry when exposed to a selected temperature and/or pressure. Vent manifold 106 may include a first hatch support 142 and a second hatch support 144 arranged adjacent to fluid inlet 124. Thermally responsive hatch 128 is supported between first hatch support 142 and second hatch support 144. In the event a thermal runaway condition exists in one of the plurality of battery cells 94, high pressure, high temperature gases will be generated. The high temperature, high pressure gases will force open the vent 100 associated with the one of the plurality of battery cells 94 and exhaust into vent manifold 106 as shown in FIG. 6B causing vent manifold 106 to deform.

The deformation of vent manifold 106 causes first hatch support 142 and second hatch support 144 to cease to exert pressure on thermally responsive hatch 128. While present in central passage 108, the high temperature, high pressure gases hold thermally responsive hatch 128 closed. Once the high temperature, high pressure gases dissipate, thermally responsive hatch 128 uncovers fluid inlet 124 as shown in FIG. 6C allowing a portion of the amount of fluid 104 to flow into vent manifold 106, pass through vent 100, and into the one of the plurality of battery cells 94 experiencing thermal runaway. The portion of the amount of fluid will reduce temperatures thereby reducing the likelihood that thermal runaway will spread to additional ones of the plurality of battery cells 94.

Reference will now follow to FIG. 7 in describing a vent manifold 156 in accordance with another non-limiting example. Vent manifold 156 includes a first manifold portion 160 connected to outer surface 97 of each of the plurality of battery cells 94 and a second manifold portion 162 that is connected to first manifold portion 160 through a thermally responsive seam 166. A flange 170 circumscribes first manifold portion 160. A flange retainer 172 circumscribes second manifold portion 162. Flange retainer 172 includes a lip (not separately labeled) that captures flange 170. A thermally responsive adhesive 174 bonds flange 170 to flange retainer 172 forming thermally responsive manifold seam 166.

In a non-limiting example, in the event a thermal runaway condition exists in one of the plurality of battery cells 94, high pressure, high temperature gases will be generated. The high temperature, high pressure gases will force open the vent 100 associated with the one of the plurality of battery cells 94 and exhaust into vent manifold 156. The gasses will flow through vent manifold 156 causing thermally responsive adhesive 174 to fail.

The high pressure, high temperature gases force second manifold portion 162 away from first manifold portion 160. However, second manifold portion 162 is held in place through an interaction between flange retainer 172 and flange 170. Once the gasses dissipate, second manifold portion 162 relaxes opening thermally responsive seam 166 allowing fluid to pass through vent manifold 156 into the one of the plurality of battery cells 94. In a manner similar to that described herein, the portion of the amount of fluid 104 will reduce temperatures thereby reducing the likelihood of thermal runaway.

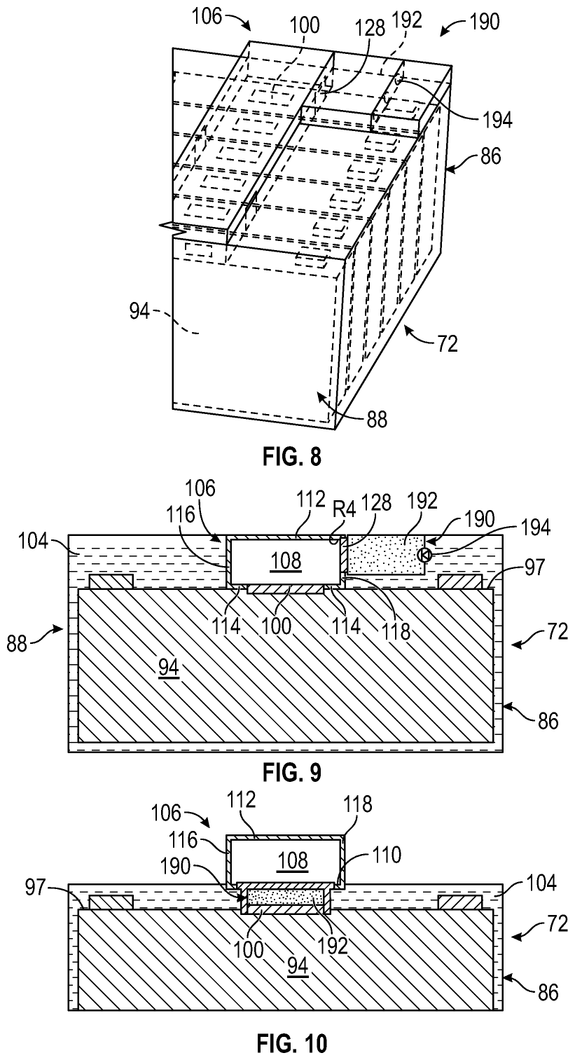

Reference will now follow to FIG. 8 and FIG. 9 in describing a fluid additive module 190 connected to second side surface 118 of vent manifold 106. Fluid additive module 190 is fluidically connected to fluid inlet 124. In a non-limiting example, once thermally responsive hatch 128 releases and opens, an amount of Thermal runaway (TR) specific material 192, that may be in various forms including liquids, solids, semi-solids and the like, flows into central passage 108. The thermal runaway specific material may take the form of an endothermic material, an inert gas generating material, an oxygen absorbing material or the like. The release of the thermal runaway specific material 192 or the opening of hatch 128 allows fluid 104 to pass through a one-way valve 194 in fluid additive module 190. A portion of the amount of fluid flows through additive module 190 carrying the thermal runaway specific material 192 into central passage 108.

The portion of the amount of fluid 104 passes through vent manifold 106 carrying with it thermal runaway specific material 192 into the one of the plurality of battery cells 94 experiencing thermal runaway. In a manner similar to that described herein, the addition of the thermal runaway specific material 192 to a portion of the amount of fluid 104 further enhances the heat absorption capacity of the fluid to reduce temperatures thereby reducing the likelihood that thermal runaway will spread to additional ones of the plurality of battery cells 94. For example, thermal runaway specific material 192 can rapidly bring temperatures in the one of the plurality of battery cells 94 to below 600° C. At this point, it should be understood that the location of fluid additive module 190 may vary. As shown in FIG. 10, fluid additive module 190 may be arranged between first surface 110 of vent manifold 106 and outer surface 97 of the plurality of battery cells 94.

At this point, it should be understood that while battery cells are shown as being immersed in a cooling fluid in a battery module, the amount of fluid passing into the vent manifold may originate from an external source including fluid introduced by first responders, fluid introduced from other fluid holding elements and the like in order to reduce battery cell temperatures and mitigate a thermal runway condition.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A battery module comprising:
a module housing including a plurality of walls defining an interior;
a plurality of battery cells arranged in the interior, each of the plurality of battery cells including a vent; and
a vent manifold is connected to each of the plurality of battery cells, the vent manifold including a central passage fluidically connected to the vent in each of the plurality of battery cells and a fluid inlet that selectively allows passage of an amount of fluid into select ones of the plurality of battery cells.

2. The battery module according to claim 1, wherein the vent manifold includes a first surface coupled to each of the plurality of battery cells, a second surface extending parallel to and spaced from the first surface, a first side surface, and a second side surface extending between and connected to the first surface and the second surface, the fluid inlet being arranged in one of the first side surface and the second side surface.

3. The battery module according to claim 2, further comprising a thermally responsive hatch disposed over the fluid inlet.

4. The battery module according to claim 3, further comprising a thermally responsive adhesive selectively connecting the thermally responsive hatch to the one of the first side surface and the second side surface.

5. The battery module according to claim 3, wherein the vent manifold includes a first hatch support arranged on one side of the fluid inlet and a second hatch support arranged on a second side of the fluid inlet, the thermally responsive hatch being selectively supported between the first hatch support and the second hatch support closing the fluid inlet.

6. The battery module according to claim 5, wherein the vent manifold is formed from a thermally responsive material configured to expand when exposed to pressurized hot gases.

7. The battery module according to claim 2, further comprising a fluid additive module connected to the vent manifold, the fluid additive module including a thermal runaway specific material that is selectively added to the amount of fluid passing through the vent manifold into the one of the plurality of battery cells.

8. The battery module according to claim 7, wherein the fluid additive module is mounted to the one of the first side surface and the second side surface over the fluid inlet.

9. The battery module according to claim 1, further comprising an amount of fluid arranged in the interior of the module housing, the fluid inlet selectively passing a portion of the amount of fluid from the interior to flow through the vent of the select ones of the plurality of battery cells.

10. The battery module according to claim 1, wherein the vent manifold includes a first manifold portion coupled to each of the plurality of battery cells and a second manifold portion connected to the first manifold portion through a thermally responsive manifold seam, the fluid inlet being arranged at the thermally responsive manifold seam.

11. A vehicle comprising:
a body including a passenger compartment;
a drive motor mounted in the body; and
a rechargeable energy storage system including a battery assembly mounted to the body, the battery assembly comprising:
a housing including a base wall and a plurality of side walls that are connected to the base wall;
a plurality of battery modules arranged in the housing, each of the plurality of battery modules including:
a module housing including a plurality of walls defining an interior;
a plurality of battery cells arranged in the interior, each of the plurality of battery cells including a vent; and
a vent manifold is connected to each of the plurality of battery cells, the vent manifold including a central passage fluidically connected to the vent in each of the plurality of battery cells and a fluid inlet that selectively allows passage of an amount of fluid into select ones of the plurality of battery cells.

12. The vehicle according to claim 11, wherein the vent manifold includes a first surface coupled to each of the plurality of battery cells, a second surface extending parallel to and spaced from the first surface, a first side surface, and a second side surface extending between and connected to the first surface and the second surface, the fluid inlet being arranged in one of the first side surface and the second side surface.

13. The vehicle according to claim 12, further comprising a thermally responsive hatch disposed over the fluid inlet.

14. The vehicle according to claim 13, further comprising a thermally responsive adhesive selectively connecting the thermally responsive hatch to the one of the first side surface and the second side surface.

15. The vehicle according to claim 13, wherein the vent manifold includes a first hatch support arranged on one side of the fluid inlet and a second hatch support arranged on a second side of the fluid inlet, the thermally responsive hatch being selectively supported between the first hatch support and the second hatch support closing the fluid inlet.

16. The vehicle according to claim 15, wherein the vent manifold is formed from a thermally responsive material configured to expand when exposed to pressurized hot gases.

17. The vehicle according to claim 12, further comprising a fluid additive module connected to the vent manifold, the fluid additive module including an amount of endothermic material that is selectively added to the amount of fluid passing through the vent manifold into the one of the plurality of battery cells.

18. The vehicle according to claim 17, wherein the fluid additive module is mounted to the one of the first side surface and the second side surface over the fluid inlet.

19. The vehicle according to claim 11, further comprising an amount of fluid arranged in the interior of the module housing, the fluid inlet selectively passing a portion of the amount of fluid from the interior to flow through the vent of the select ones of the plurality of battery cells.

20. The vehicle according to claim 11, wherein the vent manifold includes a first manifold portion coupled to each of the plurality of battery cells and a second manifold portion connected to the first manifold portion through a thermally responsive manifold seam, the fluid inlet being arranged at the thermally responsive manifold seam.
